(19) United States
(12) Patent Application Publication
(10) Pub. No.: US 2026/0117147 A1
(43) Pub. Date: Apr. 30, 2026

(54) DETERGENTS WITH IMPROVED CLEANING EFFICIENCY AND MATERIAL COMPATIBILITY

(71) Applicant: ASP Global Manufacturing GmbH, Schaffhausen (CH)

(72) Inventors: Phuong Dau, Irvine, CA (US); Joon Lee, Irvine, CA (US); Abhigyan Som, Brea, CA (US); Ann-Margret Andersson, Irvine, CA (US)

(21) Appl. No.: 19/376,717

(22) Filed: Oct. 31, 2025

Related U.S. Application Data
(60) Provisional application No. 63/714,304, filed on Oct. 31, 2024.

(51) Int. Cl. C11D 3/386; C11D 1/62; C11D 1/835; C11D 3/48

(52) U.S. Cl. CPC C11D 3/38663; C11D 1/62; C11D 1/835; C11D 3/48

(57) ABSTRACT

Detergent formulations are disclosed. An exemplary detergent includes a stabilizer, an enzyme, a non-ionic surfactant, a cationic surfactant, and water. The detergent may have a pH ranging from 8.5 to 11.5. The detergent provides superior biofilm removal efficacy and material compatibility when compared with known detergents.

### BACKGROUND

In healthcare settings, there is a need to create a clean environment, including having clean instruments within that environment. According to a study by the Centers for Disease Control and Prevention, nearly 1.7 million hospitalized patients acquire some infection while receiving care. Of these patients, more than 1-in-17 die from complications resulting from these types of infections, underscoring the need to easily and economically create clean environments in areas where patients receive such care.

While healthcare providers are typically well-trained in the techniques needed to disinfect themselves before rendering care to patients, ensuring that the equipment used by these providers is clean, especially in high-traffic environments such as emergency rooms or operating rooms, can be a challenge. This challenge is exacerbated by the fact that conventional detergents have material compatibility concerns, which may reduce the number of reprocessing cycles a medical device can endure. This can be due to, for example, increased corrosion of metal surfaces caused by existing detergent compositions.

In addition to the challenges mentioned above, many existing detergents have poor shelf life and can be difficult to ship and store economically. Poor shelf life or low stability can result in healthcare providers needing to dispose of detergent products before they are used, which leads to both unnecessary waste and expense. Moreover, for healthcare providers who use a large amount of detergents, shipping and warehousing costs can be expensive, and such additional costs are often passed on to patients receiving care.

As such, there is a need for a detergent that possesses high cleaning performance and material compatibility. Further, there is a need for a detergent that is shelf-stable for extended periods of time, is easy and economical to ship and store, and is noncorrosive. The invention in accordance with the present disclosure meets and exceeds these needs.

### BRIEF SUMMARY

Whereas conventional detergents are plagued by issues such as poor stability, shelf life, and material compatibility with medical devices, detergents disclosed herein provide excellent stability and material compatibility while at the same time providing high levels of biofilm removal efficacy, cell count reduction (CCR) activity, and overall cleaning efficiency that is currently unrivaled by conventional detergents.

As described herein, detergents of the present disclosure are capable of delivering the unusual combination of technical effects (i) high levels of biofilm soil removal efficiency that satisfies or exceeds the standards set forth in ISO 15883-5 and AAMI ST98 (see Examples 6 and 7), (ii) greater than 6 log reduction of bacterial count/population or viable bacterial cells (see Examples 6 and 7), (iii) high levels of simethicone solubilization/dispersion while avoiding unwanted high-level foaming (see Example 9), and (iv) excellent material compatibility without the use of conventional corrosion inhibitors (see Example 5).

Whereas conventional enzymatic detergents are typically pH-neutral and omit quaternary ammonium antimicrobial agents due to poor enzyme incompatibility and material compatibility issues, the detergents disclosed herein may include quaternary ammonium compounds and enzymes without experiencing problems such as foaming, instability, or corrosiveness. Detergents, as described in the present disclosure, offer advantages in terms of storage, biocompatibility, low corrosiveness, and reduced cost, thereby providing a more effective solution for reprocessing medical devices.

The detergent may contain a stabilizer, an enzyme, a non-ionic surfactant, and a cationic surfactant, and have a pH ranging from 8.5 to 11.5. For example, in some embodiments the detergent comprises 20-30% w/w of the first stabilizer, 0.2% w/w to 1.5% w/w of the enzyme, 1.0% w/w to 3.0% w/w of the non-ionic surfactant, 3.0% w/w to 6.5% w/w of the quaternary ammonium compound, 0.1% w/w to 0.2% w/w of a first pH buffer agent, 0.01% w/w to 0.03% w/w of a second pH buffer agent, 0.05% w/w to 0.15% w/w of an antifoaming agent, and 0.1% w/w to 2.0% w/w of a water softener.

The detergent may be non-corrosive to metals. For example, when the detergent is in contact with a low-carbon steel, the low-carbon steel may exhibit a corrosion rate of 0.015 mm/year or less.

The disclosed detergent can exhibit high levels of biofilm cleaning efficiency. For example, the detergent can be configured to denature proteins exposed to it, such that the amount of protein is reduced to 6.4 μg/cm² or less following contact with the detergent. The detergent can be configured to remove organic material exposed to it, such that the total organic carbon is reduced to 12.0 μg/cm² or less following contact with the detergent. The detergent can be configured to clean or remove bacteria exposed to it, such that a bacterial log cell count (cfu/cm²) is reduced by 6.0 log or more relative to a non-treated sample following contact with the detergent.

Embodiments of the present disclosure also relate to methods for cleaning an object using detergents disclosed herein. For example, some methods involve cleaning an object such as an endoscope, sometimes using an automatic endoscope reprocessor. Such methods may be carried out at an operating temperature ranging from 15° C. to 60° C.

### BRIEF DESCRIPTION OF THE SEVERAL VIEWS OF THE DRAWINGS

FIG. 1 shows a chart comparing residual protein that results from a low flow rate (250 mL/min) manual cleaning of mono-bacterial biofilms with a detergent of the present disclosure in comparison to a reference sample (with no detergent, manual cleaning) and a comparative detergent;

FIG. 2 shows a chart comparing total organic carbon (TOC) that results from low flow rate (250 mL/min) manual cleaning of mono-bacterial biofilms with a detergent of the present disclosure in comparison to a reference sample (with no detergent, manual cleaning) and a comparative detergent;

FIG. 3 shows a chart comparing the bacterial count that results from low flow rate (250 mL/min) manual cleaning of mono-bacterial biofilms with a detergent of the present disclosure in comparison to a reference sample (with no detergent, manual cleaning) and a comparative detergent;

FIG. 4 shows a graph of the residual proteins from biofilm versus the concentration of BTC® 1010-80% that results from manual cleaning of mono-bacterial biofilms when the concentration of BTC® 1010-80% is varied;

FIG. 5 shows a graph of the average TOC remaining from biofilm versus the concentration of BTC® 1010-80% that results from manual cleaning of mono-bacterial biofilms when the concentration of BTC® 1010-80% is varied;

FIG. 6 shows a graph of the Log reduction of bacteria in biofilm versus the concentration of BTC® 1010-80% that results from manual cleaning of mono-bacterial biofilms when the concentration of BTC® 1010-80% is varied;

FIG. 7 shows a chart comparing the simethicone solubility of a detergent of the present disclosure in comparison to a water sample and two comparative detergents;

FIG. 8 shows relative solubility characteristics of blue-stained simethicone after mixing with a detergent of the present disclosure in comparison to a water sample and two comparative detergents; and

FIG. 9 shows a series of TOSI® coupons that were cleaned using sonication with a detergent of the present disclosure in comparison to a control sample and three comparative detergents.

### DETAILED DESCRIPTION

Device reprocessing in healthcare requires a detergent that simultaneously removes biofilm soils, achieves superior cleaning, remains low-foaming and storage-stable, and is materially compatible with the article being reprocessed.

Conventional enzymatic detergents typically avoid the use of quaternary ammonium compounds (QACs) to preserve enzyme activity and material compatibility. Enzymes are delicate proteins while QACs are strong cationic surfactants. Therefore, especially in alkaline solutions, QACs are more likely to adversely affect the structure and/or function of enzymes. Therefore, literature generally warns against putting them together in a high-pH cleaner. Consequently, there was a recognized incompatibility between an enzyme-based cleaning agents and the presence of QACs.

One embodiment of the detergents disclosed herein is a formulation containing (i) a glycol stabilizer at relatively high loading, (ii) a protease (such as subtilisin), (iii) a low-foam non-ionic alcohol-alkoxylate surfactant, and (iv) a QAC (such as DDAC), maintained in a target alkaline pH range using carbonate buffering. Such detergents unexpectedly remain single-phase and preserve enzyme performance while enabling rapid cleaning and biofilm removal.

The detergent formulations disclosed herein provide a balance between enzyme stability, micelle formation, interfacial tension, and ionic strength. Although enzyme-containing detergents disclosed herein may include a QAC and have a mildly basic pH, the enzyme activity is maintained. Furthermore, detergents disclosed herein exhibit excellent solubilization characteristics, optimized surface tension characteristics that enable soils to be lifted without causing foaming or instability, and ionic strength characteristics that ensure adequate solubilization and stability of the detergents.

Detergents disclosed herein provide excellent stability and material compatibility, while simultaneously offering high levels of biofilm removal efficacy, CCR activity, and overall cleaning efficiency that are currently unrivaled by conventional detergents. For example, some detergents disclosed herein are capable of delivering the unusual combination of (i) high levels of biofilm soil removal efficiency that satisfies or exceeds the standards set forth in ISO 15883-5 and AAMI ST98 (e.g., see Examples 6 and 7), (ii) greater than 6 log reductions of bacterial log cell count (e.g., see Examples 6 and 7), (iii) unusually high levels of simethicone solubilization/dispersion that avoid unwanted foaming (e.g., see Example 9), and (iv) excellent material compatibility without the use of conventional corrosion inhibitors (e.g., see Example 5).

### Definitions

Throughout the present disclosure, % w/w denotes a part by weight of a given component relative to the total weight of the detergent. Similarly, % v/v denotes a part by volume of a given component relative to the total volume of an in-use detergent.

As used herein, ranges and amounts can be expressed as “about” a particular value or range. “About” also includes the exact amount. Hence, “about 1.0% w/w” means “about 1.0% w/w” and “1.0% w/w.” In some embodiments, “about” means within 5% of the value; hence “about 1.0% w/w” means 0.095-1.05% w/w. In some embodiments, “about” means within 4% of the value; hence “about 1.0% w/w” means 0.096-1.04% w/w. In some cases, “about” means within 3% of the value; hence “about 1.0% w/w” means 0.097-1.03% w/w. In some cases, “about” means within 2% of the value; hence “about 1.0% w/w” means 0.098-1.02% w/w. In some cases, “about” means within 1% of the value; hence “about 1% w/w” means 0.099-1.01% w/w. Generally, the term “about” includes an amount that would be expected to be within experimental error.

As used herein, the term “stabilizer” refers to a chemical additive that helps to maintain the physical and/or chemical stability of a detergent and/or the active ingredients of a detergent. Stabilizers can be used to ensure that a detergent remains effective over its shelf life, or to increase the shelf life of a detergent without a stabilizer.

### Detergents

Embodiments of the detergent in accordance with the present disclosure include a first stabilizer, an enzyme, a non-ionic surfactant, a cationic surfactant, and an amount of water. The detergent has a pH ranging from about 8.5 to about 11.5.

The detergent, as described in the present disclosure, will include a stabilizer. The stabilizer may be any glycol compound in liquid form. Particularly, the stabilizer may be any glycol compound having C₂-C₄. More particularly, one or more of the following stabilizers can be used as part of the detergent in accordance with the present disclosure: ethylene glycol, propylene glycol, butylene glycol, or glycerin. In an embodiment, the stabilizer is propylene glycol. The stabilizer may be included in the detergent to reduce the surface tension between organic matter and aqueous media. Specifically, the stabilizer may be included to reduce the surface tension between water and any surfactants present in the detergent.

The stabilizer may be present in the detergent in an amount ranging from about 15% w/w to about 50% w/w. In some embodiments, when a plurality of stabilizers is included, the amount of each stabilizer may range from about 15% w/w to about 50% w/w; in other embodiments, when a plurality of stabilizers is included, the total amount of all of the stabilizers may range from about 15% w/w to about 50% w/w. Particularly, the stabilizer may be present in an amount ranging from about 15% w/w to about 40% w/w, about 15% w/w to about 30% w/w, about 20% w/w to about 50% w/w, about 20% w/w to about 40% w/w, or about 20% w/w to about 30% w/w. In some embodiments the stabilizer may be present in an amount ranging from about 15% w/w to about 20% w/w, or from about 20% w/w to about 25% w/w or from about 25% w/w to about 30% w/w, or from about 30% w/w to about 35% w/w, or from about 35% w/w to about 40% w/w, or from about 40% w/w to about 45% w/w, or from about 45% w/w to about 50% w/w. In an embodiment, the stabilizer is present in an amount of about 25% w/w. When the stabilizer is included in these amounts, the detergent may have improved stability (i.e., longer shelf life), improved material compatibility, and be more economical to produce.

The disclosed detergent may include an enzyme or a mixture of enzymes. The enzyme may be of any class of enzymes with proteolytic activity, capable of breaking down proteins into smaller peptides. For example, the enzyme may be any class of protease. The enzyme may include a cysteine protease, a serine protease, a threonine protease, or any combination thereof. In some embodiments the enzyme includes subtilisin. The enzyme may be included in the detergent to effectively remove biofilm from a soiled article, such as a soiled medical device, e.g., an endoscope. The enzyme may include a commercial enzyme product, which contains 5-7.5% subtilisin.

The enzyme may be present in the detergent in an amount up to about 5.0% w/w. When a plurality of enzymes is included, the amount of each enzyme may be up to about 5.0% w/w, or the total amount of all of the enzymes may be up to 5.0% w/w. In some embodiments, the amount of the enzyme is up to about 2.0% w/w. Particularly, the enzyme may be present in an amount ranging from about 0.1% w/w to about 1.5% w/w, about 0.2% w/w to about 1.5% w/w, about 0.3% w/w to about 1.5% w/w, about 0.4% w/w to about 1.2% w/w, about 0.5% w/w to about 1.2% w/w, about 0.6% w/w to about 1.2% w/w, about 0.7% w/w to about 1.2% w/w, about 0.8% w/w to about 1.1% w/w, or about 0.9% w/w to about 1.1% w/w. In some embodiments the amount of the enzyme can range from about 0.1% w/w to about 0.5% w/w, or from about 0.5% w/w to about 1.0% w/w, or from about 1.0% w/w to about 1.5% w/w, or from about 1.5% w/w to about 2.0% w/w, or from about 2.0% w/w to about 2.5% w/w, or from about 2.5% w/w to about 3.0% w/w, or from about 3.0% w/w to about 3.5% w/w, or from about 3.5% w/w to about 4.0% w/w, or from about 4.0% w/w to about 4.5% w/w, or from about 4.5% w/w to about 5.0% w/w. When the enzyme is included in these amounts as disclosed, the detergent may have improved stability (i.e., longer shelf life), improved material compatibility, and be more economical to produce.

As used herein, the term “surfactant” refers to an amphiphilic organic compound that allows two otherwise immiscible substances to mix together. Detergents of the present disclosure include at least one surfactant, e.g., a non-ionic surfactant, a cationic surfactant, or a combination thereof. Notably, the non-ionic surfactant may exhibit low foaming properties. More particularly, one or more of the following non-ionic surfactants may be used as part of the detergent in accordance with the present disclosure: a C₁₂-C₁₄ fatty alcohol, a polyglycol ether non-ionic surfactant, an alcohol alkoxylate, a poly(ethylene glycol)-block-poly(propylene glycol)-block-poly(ethylene glycol), Triton® X-100 (1-5% polyethylene glycol, >80% octylphenol phenoxyethanol), Polysorbate 80 (polyoxyethylene(20)sorbitan monooleate), or Tergitol® 1× Min foam (>97.0% alcohol alkoxylate) as the non-ionic surfactant. Optionally, the detergent may include an alcohol alkoxylate, such as Tergitol® 1× Min foam. As used herein, the term “alcohol alkoxylate” refers to a copolymer of a polyethylene and a polypropylene ether glycol.

The non-ionic surfactant may be included in the detergent to solubilize any quaternary compounds present in the detergent and/or to solubilize the organic matter from the breakdown soils during cleaning. Additionally, the non-ionic surfactant may reduce surface tension between organic matter and aqueous media. Further, the non-ionic surfactant may have an effect of improving the biofilm removal efficacy of the detergent.

The non-ionic surfactant may be present in the detergent in an amount ranging from about 1% w/w to about 8% w/w, or from about 1% w/w to about 5% w/w. When multiple non-ionic surfactants are included, the amount of each non-ionic surfactant may range from about 1% w/w to about 8% w/w, or the total amount of all of the non-ionic surfactants may range from about 1% w/w to about 8% w/w. Particularly, the non-ionic surfactant may be present in an amount ranging from about 1% w/w to about 7% w/w, about 1% w/w to about 6% w/w, about 1% w/w to about 5% w/w, about 1% w/w to about 4% w/w, about 1% w/w to about 3% w/w, or about 1.5% w/w to about 2.5% w/w. In some embodiments the non-ionic surfactant may be present in an amount ranging from about 1% w/w to about 1.5% w/w, or from about 1.5% w/w to about 2.0% w/w, or from about 2.0% w/w to about 2.5% w/w, or from about 2.5% w/w to about 3.0% w/w, or from about 3.0% w/w to about 3.5% w/w, or from about 3.5% w/w to about 4.0% w/w, or from about 4.0% w/w to about 4.5% w/w, or from about 4.5% w/w to about 5.0% w/w, or from about 4.0% w/w to about 5.5% w/w, or from about 5.5% w/w to about 6.0% w/w, or from about 6.0% w/w to about 6.5% w/w, or from about 6.5% w/w to about 7.0% w/w, or from about 7.0% w/w to about 7.5% w/w, or from about 7.5% w/w to about 8.0% w/w. In some embodiments, the non-ionic surfactant is present in an amount of about 2% w/w. When the non-ionic surfactant is included in these amounts, the detergent may have improved stability (i.e., longer shelf life), improved material compatibility, and be more economical to produce.

As used herein, the term “quaternary ammonium compound” refers to an ionic compound containing a positively-charged polyatomic moiety having the general structure [NR₁ R₂R₃R₄]+, where R₁-R₄ represent organic moieties, and a negatively-charged counter ion.

The detergent may include a cationic surfactant. In particular, this cationic surfactant can be a quaternary ammonium compound, which may be any alkyl quaternary ammonium compound or aromatic alkyl quaternary ammonium compound. Particularly, in various embodiments one or more of the following compounds may be included in the detergent: n-alkyl dimethyl benzyl ammonium chloride, n-alkyl dimethyl ethylbenzyl ammonium chloride, or didecyldimethylammonium chloride (DDAC). In some embodiments, the quaternary ammonium compound may include didecyldimethylammonium chloride (DDAC). The detergent may include a commercial quaternary ammonium compound such as BTC® 1010-80% (80-82% DDAC), Bardac® 2280 (80% DDAC), or equivalent.

The quaternary ammonium compounds as disclosed herein may be included in the detergent to remove and/or inactivate viable cells from a biofilm or sample exposed to the detergent. Further, these quaternary ammonium compounds may be included in the detergent to facilitate improved biofilm removal efficacy.

These quaternary ammonium compounds may be present in the detergent in accordance with the present disclosure in an amount ranging from about 0.80% w/w to about 8% w/w. When a plurality of quaternary ammonium compounds is included, the amount of each quaternary ammonium compound may range from about 0.80% w/w to about 8% w/w, or the total amount of all of the quaternary ammonium compounds may range from about 0.80% w/w to about 8% w/w. Particularly, these quaternary ammonium compounds may be present in an amount ranging from about 1% w/w to about 7% w/w, about 2% w/w to about 6% w/w, or about 3% w/w to about 5% w/w. In some embodiments the amount of the quaternary ammonium compounds ranges from about 1% w/w to about 1.5% w/w, or from about 1.5% w/w to about 2.0% w/w, or from about 2.0% w/w to about 2.5% w/w, or from about 3.0% w/w to about 3.5% w/w, or from about 3.5% w/w to about 4.0% w/w, or from about 4.0% w/w to about 4.5% w/w, or from about 4.5% w/w to about 5.0% w/w, or from about 5.0% w/w to about 5.5% w/w, or from about 5.5% w/w to about 6.0% w/w, or from about 6.0% w/w to about 6.5% w/w, or from about 6.5% w/w to about 7.0% w/w, or from about 7.0% w/w to about 7.5% w/w, or from about 7.5% w/w to about 8.0% w/w. In an embodiment, the cationic surfactant is present at about 4% w/w. When the cationic surfactant is included in these amounts, the detergent may exhibit improved stability (i.e., a longer shelf life), enhanced biocompatibility properties, improved material compatibility, improved activity and/or solubility toward simethicone, and be more economical to produce.

The stability of the detergent can be improved by controlling the relative amounts of the non-ionic surfactant and the quaternary ammonium compound. For example, in some embodiments, a minimum of about 2% w/w of the non-ionic surfactant is needed to stabilize the detergent when the amount of the quaternary ammonium compound is at least about 5% w/w. In other embodiments, a minimum of about 5% w/w of the non-ionic surfactant is needed to stabilize the detergent when the amount of the quaternary ammonium compound is at least about 10% w/w. In some embodiments, the detergent contains at least about 5% w/w of BTC® 1010-80% and at least about 2% w/w or more of Tergitol® 1× Min foam 1× Surfactant. In some embodiments, the detergent contains at least about 10% w/w of BTC® 1010-80% and at least about 5% w/w or more of Tergitol® 1× Min foam 1× Surfactant.

Stability of the detergent can also be enhanced by controlling the amount of the stabilizer relative to the amount of the surfactants. In some embodiments, increasing the amount of stabilizer can enable a corresponding increase in the cationic surfactant when a non-ionic surfactant is present. For example, the amount BTC® 1010-80% in a detergent of the present disclosure can be increased to at least 5% w/w when the detergent includes Tergitol® 1× Min foam 1× Surfactant and at least 17% w/w of propylene glycol. The presence of propylene glycol may ensure that the detergent, containing at least 5% w/w of the cationic surfactant, maintains satisfactory stability. Alternatively, the amount BTC® 1010-80% can be increased to 10% w/w when a detergent containing Tergitol® 1× Min foam 1× Surfactant includes at least 20% w/w of propylene glycol. In various embodiments, detergents with excellent stability characteristics can be obtained when they contain about 2% w/w of Tergitol® 1× Min foam 1× Surfactant, about 6% w/w of BTC® 1010-80%, and about 25% w/w of propylene glycol.

In some embodiments, the detergent may include a hydrotrope, which is a substance that can solubilize hydrophobic substances within an aqueous solution. Hydrotropes generally do not form micelles as readily as surfactants because the hydrophobic moieties of hydrotropes are too small to do so. The hydrotrope can be, for example, an anionic, cationic, or non-ionic hydrotrope. The hydrotrope can be inorganic or organic and can comprise surfactant activity.

Organic solvents can be sulfonated to create a sulfonic acid, which can then be neutralized to form a hydrotrope salt. The hydrotrope can comprise at least one of an alkanoic acid (e.g., sulfonic acid, carboxylic acid), an aromatic sulfonic acid, an aromatic carboxylic acid, and a salt of any thereof. The salt of the alkanoic acid can be, for example, a sodium alkanoate salt. The hydrotrope can comprise a toluenesulfonyl functional group. The hydrotrope can comprise at least one of urea, ptoluenesulfonic acid (e.g., 4-methylbenzene-1-sulfonic acid), xylene sulfonic acid (e.g., 2,5-dimethylbenzenesulfonic acid), cumene sulfonic acid (e.g., 2(or 4)-(isopropyl) benzenesulphonic acid), and a salt of any thereof. If an anionic hydrotrope is employed, the hydrotrope can comprise at least one of Cola®Trope INC, Cola®Trope OD, and Cola®Trope CA All three Cola®Trope substances are available from Colonial Chemical, Inc., South Pittsburgh, Tennessee, USA All three Cola®Trope substances comprise sodium alkanoate.

The hydrotrope can be present in the detergent compositions of the present disclosure in any effective amount. For example, the detergent compositions can comprise at least 0.01% hydrotrope by weight, based on the total weight of the detergent composition, such as at least 0.1%, 1%, 5%, 10%, 15%, 20%, or 25% hydrotrope by weight. The detergent composition can comprise 30% or less hydrotrope by weight based on the total weight of the detergent composition, such as 25% or less, 20% or less, 15% or less, 10% or less, 5% or less, 1% or less, or 0.1% or less hydrotrope by weight. The detergent composition can comprise 0.01% to 30% hydrotrope by weight based on the total weight of the detergent composition, such as, for example, 0.1% to 30%, 1% to 30%, 5% to 20%, 5% to 15%, 10% to 20%, or 10% to 15% hydrotrope by weight. In some embodiments, the detergent does not include a hydrotrope.

The detergent may contain a certain amount of water. The amount of water present in the detergent is not particularly limited. For example, the water may be present in a dilute amount, allowing the detergent to be used in cleaning applications. For example, the water may be present in the detergent in an amount ranging from about 25% w/w to 70% w/w. In an embodiment, the water may be present in an amount of about 66.40% w/w.

The type of water included in the detergent is not particularly limited and may include deionized water or purified water.

The detergent may also include an antifoaming agent or defoamer, such as a silicon-containing antifoaming agent. The antifoaming agent may include Antifoam C Emulsion (aqueous emulsion containing 30% active silicone). The defoamer may be included in the detergent to eliminate and/or prevent the formation of foam within the detergent and/or to lower the foam stability of the detergent.

The defoamer may be present in the detergent in an amount ranging from about 0.001% w/w to about 0.02% w/w. When a plurality of defoamers is included, the amount of each defoamer may range from about 0.001% w/w to about 0.02% w/w, or the total amount of all of the defoamers may range from about 0.001% w/w to about 0.02% w/w. Particularly, the defoamer may be present in an amount ranging from about 0.001% w/w to about 0.015% w/w, about 0.001% w/w to about 0.01% w/w. In an embodiment, the defoamer may be present at about 0.01% w/w. In some embodiments, the amount of the antifoaming agent ranges from about 0.001% w/w to about 0.005% w/w, or from about 0.005% w/w to about 0.010% w/w, or from about 0.010% w/w to about 0.015% w/w, or from about 0.015% w/w to about 0.020% w/w. When the defoamer is included in these amounts, the detergent may have improved stability (i.e., longer shelf life), improved material compatibility, and be more economical to produce.

The detergent may also include a second stabilizer. Particularly, one or more of the following second stabilizers may be used as part of the detergent in accordance with the present disclosure: isopropanol, propanol, ethanol, or methanol. In an embodiment, the second stabilizer is isopropanol. The second stabilizer may be included in the detergent to reduce the surface tension between organic matter and aqueous media.

The second stabilizer may be present in the detergent in an amount up to about 10% w/w. When a plurality of second stabilizers is included, the amount of each second stabilizer may be up to about 10% w/w, or the total amount of all of the second stabilizers may be up to about 10% w/w. Particularly, the enzyme may be present in an amount up to about 8% w/w, up to about 5% w/w, up to about 3% w/w, or up to about 1% w/w. In some embodiments, the amount of the enzyme ranges from about 0.1% w/w to about 8% w/w. For example, in some embodiments the amount of the enzyme ranges from about 0.1% w/w to about 0.5% w/w, or from about 0.5% w/w to about 1.0% w/w, or from about 1.0% w/w to about 1.5% w/w, or from about 1.5% w/w to about 2.0% w/w, or from about 2.0% w/w to about 2.5% w/w, or from about 2.5% w/w to about 3.0% w/w, or from about 3.0% w/w to about 3.5% w/w, or from about 3.5% w/w to about 4.0% w/w, or from about 4.0% w/w to about 4.5% w/w, or from about 4.5% w/w to about 5.0% w/w, or from about 5.0% w/w to about 5.5% w/w, or from about 5.5% w/w to about 6.0% w/w, or from about 6.0% w/w to about 6.5% w/w, or from about 6.5% w/w to about 7.0% w/w, or from about 7.0% w/w to about 7.5% w/w, or from about 7.5% w/w to about 8.0% w/w.

In some embodiments, the detergent comprises a first pH buffer agent, a second pH buffer agent, or a combination thereof.

Detergents in accordance with the present disclosure may also include at least one pH buffer agent used to control the pH range of the detergent. The detergent may also include a first pH buffer agent. Specifically, the first pH buffer agent can be any biological buffer agent with a pKa value greater than or equal to about 8.5. More particularly, one or more of the following first pH buffer agents may be used as part of the detergent in accordance with the present disclosure: sodium bicarbonate, 4-morpholineethanesulfonic acid, sodium phosphate tribasic, or 3-(cyclohexylamino)-1-propanesulfonic acid.

The first pH buffer agent may be present in the detergent in an amount up to about 1% w/w. When a plurality of first pH buffer agents is included, the amount of each first pH buffer agent may be up to about 1% w/w, or the total amount of all of the first pH buffer agents may be up to about 1% w/w. Particularly, the first pH buffer agent may be present in an amount ranging from about 0.05% w/w to about 1% w/w, about 0.05% w/w to about 0.9% w/w, about 0.05% w/w to about 0.8% w/w, about 0.05% w/w to about 0.7% w/w, about 0.05% w/w to about 0.6% w/w, about 0.05% w/w to about 0.5% w/w, about 0.05% w/w to about 0.4% w/w, about 0.05% w/w to about 0.3% w/w, or about 0.05% w/w to about 0.2% w/w. In some embodiments, the amount of the first pH buffer agent ranges from about 0.01% w/w to about 0.05% w/w, or from about 0.05% w/w to about 0.10% w/w, or from about 0.10% w/w to about 0.15% w/w, or from about 0.15% w/w to about 0.20% w/w, or from about 0.20% w/w to about 0.25% w/w, or from about 0.25% w/w to about 0.30% w/w, or from about 0.30% w/w to about 0.35% w/w, or from about 0.35% w/w to about 0.40% w/w, or from about 0.40% w/w to about 0.45% w/w, or from about 0.45% w/w to about 0.50% w/w, or from about 0.50% w/w to about 0.55% w/w, or from about 0.55% w/w to about 0.60% w/w, or from about 0.60% w/w to about 0.65% w/w, or from about 0.65% w/w to about 0.70% w/w, or from about 0.70% w/w to about 0.75% w/w, or from about 0.75% w/w to about 0.80% w/w, or from about 0.80% w/w to about 0.85% w/w, or from about 0.85% w/w to about 0.90% w/w, or from about 0.90% w/w to about 0.95% w/w, or from about 0.95% w/w to about 1.0% w/w. In an embodiment, the first pH buffer agent is present in an amount of about 0.150% w/w.

The detergent in accordance with the present disclosure may also include a second pH buffer agent. Particularly, one or more of the following second pH buffer agents may be used as part of the detergent in accordance with the present disclosure: sodium carbonate, sodium hydroxide, sodium phosphate dibasic, or hydrochloric acid.

The second pH buffer agent may be present in the detergent in an amount up to about 0.2% w/w. When a plurality of second pH buffer agents is included, the amount of each second pH buffer agent may be up to about 0.2% w/w, or the total amount of all of the second pH buffer agents may be up to about 0.2% w/w. Particularly, the second pH buffer agent may be present in an amount up to about 0.1% w/w or up to about 0.05% w/w. In some embodiments the amount of the second pH buffer agent ranges from about 0.01% w/w to about 0.02% w/w, or from about 0.02% w/w to about 0.03% w/w, or from about 0.03% w/w to about 0.04% w/w, or from about 0.04% w/w to about 0.05% w/w, or from about 0.05% w/w to about 0.06% w/w, or from about 0.06% w/w to about 0.07% w/w, or from about 0.07% w/w to about 0.08% w/w, or from about 0.08% w/w to about 0.09% w/w, or from about 0.09% w/w to about 0.10% w/w. In an embodiment, the second pH buffer agent is present in an amount of about 0.02% w/w.

The detergent may include a carbonate buffer (such as a combination of sodium bicarbonate and sodium carbonate). The carbonate buffer concentration may range, for example, from about 2 mM (0.002M) to about 150 mM (0.15M). The stability of the detergent can be controlled by adjusting the concentration of the carbonate buffer. For example, when the concentration of the carbonate buffer exceeds about 150 mM, the detergent may become less stable. In some embodiments, the detergent becomes less stable when the concentration of the carbonate buffer exceeds about 200 mM.

The detergent may include 3-(cyclohexylamino)-1-propanesulfonic acid (CAPS) as the first buffer. The stability of a CAPS-containing buffer can be enhanced by including a second stabilizer, such as isopropanol. In some embodiments, the detergent comprises CAPS and at least about 10% w/w of isopropanol.

One or more pH buffer agents may be included in the detergent to regulate its pH. In various embodiments, the first pH buffer agent and/or the second pH buffer agent may be included in the detergent to regulate its pH to a range of about 8.5 to about 11.5. In some embodiments, the pH ranges from 9.5 to 10.5. It is important to regulate the pH of the detergent to be within the target range, as an overly acidic or overly basic detergent may damage the article being cleaned, such as a flexible endoscope or another device.

The detergent may also include a water softener. As used herein, the term “water softener” refers to a compound or mixture of compounds that remove hard ions such as calcium (Ca²⁺) and magnesium (Mg²⁺) from water and replace them with soft ions such as sodium (Na⁺) or potassium (K⁺). Particularly, one or more of the following water softeners may be used as part of the detergent in accordance with the present disclosure: tetrasodium-N, N-bis(carboxymethyl)-L-glutamate, N, N-(carbamoylmethyl) iminodiacetic acid, or ethylenediaminetetraacetic acid. In an embodiment, the water softener is tetrasodium-N, N-bis(carboxymethyl)-L-glutamate. The water softener may be included in the detergent to remove minerals from water, such as calcium and magnesium.

The water softener may be present in the detergent in an amount ranging from about 0.04% w/w to about 8% w/w. When a plurality of water softeners is included, the amount of each water softener may range from about 0.04% w/w to about 8% w/w, or the total amount of all of the water softeners may range from about 0.04% w/w to about 8% w/w. Particularly, the water softener may be present in an amount ranging from about 0.1% w/w to about 8% w/w, about 0.04% w/w to about 5% w/w, about 0.04% w/w to about 4% w/w, about 0.04% w/w to about 3% w/w, about 0.04% w/w to about 2% w/w, about 0.04% w/w to about 1% w/w, or about 0.04% w/w to about 0.5% w/w. In some embodiments the amount of the water softener ranges from about 0.05% w/w to about 0.1% w/w, or from about 0.1% w/w to about 0.2% w/w, or from about 0.2% w/w to about 0.3% w/w, or from about 0.3% w/w to about 0.4% w/w, or from about 0.4% w/w to about 0.5% w/w, or from about 0.5% w/w to about 0.6% w/w, or from about 0.6% w/w to about 0.7% w/w, or from about 0.7% w/w to about 0.8% w/w, or from about 0.8% w/w to about 0.9% w/w, or from about 0.9% w/w to about 1.0% w/w, 1.0% w/w, or from about 1.0% w/w to about 2.0% w/w, or from about 2.0% w/w to about 3.0% w/w, or from about 3.0% w/w to about 4.0% w/w, or from about 4.0% w/w to about 5.0% w/w, or from about 5.0% w/w to about 6.0% w/w, or from about 6.0% w/w to about 7.0% w/w, or from about 7.0% w/w to about 8.0% w/w. In an embodiment, the water softener may be present in an amount of about 0.40% w/w. When the water softener is included in these amounts, the detergent may have improved stability (i.e., longer shelf life), improved material compatibility, and be more economical to produce.

The detergent may also include a color additive. The color additive may be any nontoxic and biocompatible color additive that is safe for users. Particularly, one or more of the following color additives may be used as part of the detergent in accordance with the present disclosure: D&C Green No. 5, FD&C Blue No. 1, or FD&C Yellow No. 5. In an embodiment, the color additive is D&C Green No. 5. The color additive may be included in the detergent to impart a color on the detergent for aesthetic reasons, and/or to alert a user that the detergent has been added to the cleaning basin, and/or to alert a user that the detergent is present on a cleaned article, e.g., a cleaned medical device such as a flexible endoscope. The color additive may be present in the detergent in an amount ranging from about 0.01% w/w to about 0.04% w/w. The color additive may be present in an amount ranging from about 0.01% w/w to about 0.02% w/w, or from about 0.02% w/w to about 0.03% w/w, or from about 0.03% w/w to about 0.04% w/w. In an embodiment, the color additive is present in an amount of about 0.02% w/w.

In some embodiments the detergent comprises about 20% w/w to about 30% w/w of the first stabilizer, about 0.2% w/w to about 1.5% w/w of the enzyme, about 1.0% w/w to about 3.0% w/w of the non-ionic surfactant, about 3.0% w/w to about 5.0% w/w of the quaternary ammonium compound, about 0.1% w/w to about 0.2% w/w of the first pH buffer agent, about 0.01% w/w to about 0.03% w/w of the second pH buffer agent, about 0.05% w/w to about 0.15% w/w of the antifoaming agent, and about 0.1% w/w to about 1.0% w/w of the water softener.

In some embodiments the detergent comprises about 20% w/w to about 30% w/w of a stabilizer comprising propylene glycol, about 0.2% w/w to about 1.5% w/w of an enzyme comprising subtilisin, about 1.0% w/w to about 3.0% w/w of a non-ionic surfactant comprising an alcohol alkoxylate, about 3.0% w/w to about 8.0% w/w of an antimicrobial agent comprising a quaternary ammonium compound preferably including didecyldimethylammonium chloride, about 0.1% w/w to about 0.2% w/w of a first pH buffer agent comprising sodium bicarbonate, about 0.01% w/w to about 0.03% w/w of a second pH buffer agent comprising sodium carbonate, optionally about 0.05% w/w to about 0.15% w/w of the antifoaming agent comprising an aqueous silicone emulsion, and optionally about 0.1% w/w to about 4.0% w/w of a water softener comprising tetrasodium-N, N-bis(carboxy methyl)-L-glutamate.

Detergents of the present disclosure may also be substantially non-corrosive to metals. Particularly, detergents of the present disclosure may be substantially non-corrosive to metals despite not including a corrosion inhibitor. For example, when the detergent is used in contact with a low-carbon steel, a corrosion rate of the low-carbon steel can be 0.015 mm/year or less. More particularly, a corrosion rate of about 0.011 mm/year or less may occur when the detergent is used in the presence of a low-carbon steel. Such non-corrosive properties would not be expected in the relevant art, as conventional detergents generally have corrosion rates of greater than about 0.03 mm/year when in the presence of low carbon steel, often despite the inclusion of one or more corrosion inhibitors. As illustrated in Example 4, the surprising non-corrosive activity may be due to the presence of cationic surfactants (such as a quaternary ammonium compound), which are not known to have anti-corrosion activity and are not commonly used as corrosion inhibitors.

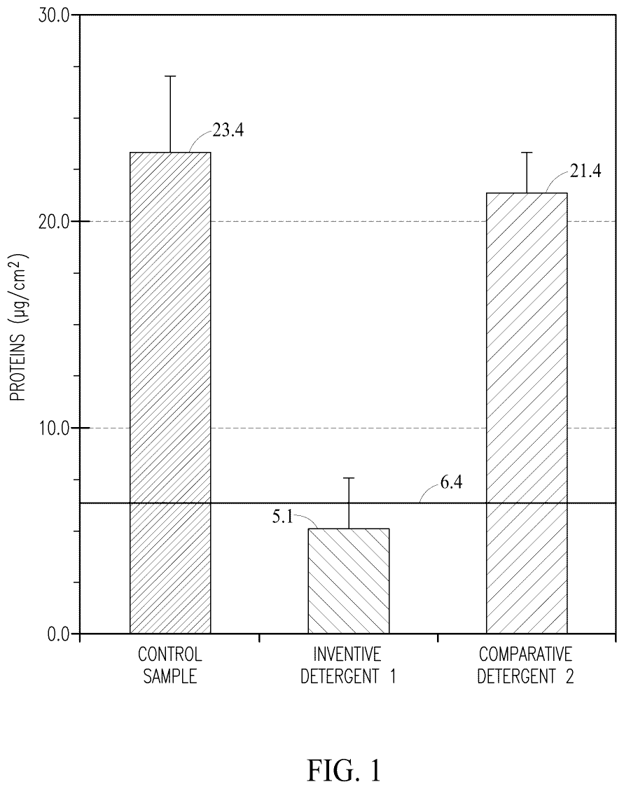

Specifically, as illustrated in Table 1 in Example 4 below, when low carbon steel samples were exposed to (1) detergents of the present disclosure (labelled as “Inventive Detergents 1-3” in FIG. 1), (2) conventional detergents (labelled as “Comparative Detergents 1-4” in FIG. 1), and (2) 400 ppm hard water (labelled as “Reference Sample” in FIG. 1), the inventive detergents of the present disclosure had improved corrosion inhibition activity on low carbon steel even without the additional of a corrosion inhibitor.

The detergent may also be configured to denature a protein exposed to the detergent. Particularly, the detergent of the present disclosure may be configured to denature a protein exposed to the detergent such that a remaining protein present on a soiled article is about 6.4 μg/cm² or less, or about 4.0 μg/cm² or less. More particularly, the detergent of the present disclosure may be configured to denature a protein exposed to the detergent, such that a remaining protein present on a soiled article, e.g., a medical device such as a flexible endoscope, is about 3.7 μg/cm² or less.

The detergent may also be configured to remove an organic material exposed to the detergent. Particularly, the detergent may be configured to remove an organic material exposed to the detergent such that a remaining organic carbon present on an article is about 8 μg/cm² or less. More particularly, the detergent of the present disclosure may be configured to remove an organic material exposed to the detergent such that a remaining organic carbon present on an article is about 12.0 μg/cm² or less, or about 7.4 μg/cm² or less.

Embodiments of the detergent in accordance with the present disclosure have exceptional CCR activity, such that a bacterial log cell count (cfu/cm²) is reduced by approximately 6.0 log or more relative to a non-treated control sample. For example, the detergent may be configured to clean a soiled sample exposed to the detergent such that an average reduction of bacterial log cell count is about 6.8 cfu/cm² or more.

An in-use detergent is also provided. The in-use detergent in accordance with the present disclosure includes the detergent of the present disclosure and an amount of water. In an embodiment, the in-use detergent may be a diluted form of the detergent of the present disclosure, and thus, may be used to clean articles that are particularly sensitive to basic solutions. The amount of water present in the in-use detergent is not particularly limited. The water may be present in a dilute amount, allowing the in-use detergent to be used in cleaning applications. For example, the water may be present in the in-use detergent in an amount ranging from about 1% v/v to about 100% v/v.

The type of water included in the in-use detergent is not particularly limited and may include deionized water, purified water, or hard water. Hard water may include water containing metal ions, such as calcium and/or magnesium, in an amount ranging from about 200 ppm to about 400 ppm. Particularly, in the in-use detergent of the present disclosure, hard water may be used.

The in-use detergent may have a pH ranging from about 7.0 to about 9.5; an overly acidic or overly basic in-use detergent may damage the article being cleaned.

### Cleaning Methods

The present disclosure also includes methods of using the detergents described herein to clean objects. For example, some embodiments relate to methods for cleaning an object in which at least one detergent described herein is applied to an object.

The detergent and in-use detergent in accordance with the present disclosure may be used for manual cleaning, in washer equipment, and/or in automatic endoscope reprocess equipment. The method for cleaning or disinfecting an object may be applied to an endoscope. The method for cleaning or disinfecting the object may be carried out using an automatic endoscope reprocessor.

The disclosed method may be applied at an operating temperature from about 10° C. to about 150° C. In some embodiments the operating temperature ranges from about 10° C. to about 100° C., or from about 10° C. to about 90° C., or from about 10° C. to about 90° C., or from about 15° C. to about 80° C., or from about 15° C. to about 70° C., or from about 15° C. to about 60° C., or from about 15° C. to about 50° C.

Furthermore, the detergent and in-use detergent of the present disclosure are compatible with all standard materials used to construct medical devices and all standard materials used to construct washer-disinfectors systems.

Detergents in accordance with the present disclosure can be prepared using the following steps, and for clarity, preparation details pertaining to one specific embodiment of said detergent will be used. However, a person having ordinary skill in the art would understand that these steps can be followed using different quantities or using an acceptable substitution of a given component as disclosed as being appropriate herein.

### EXAMPLES

The invention is further illustrated by the following examples. The examples below are non-limiting and merely representative of various aspects of the invention.

### Reference Example 1: Preparation of “Reference Sample”

A non-detergent reference sample was prepared by adjusting the mineral content of hard water to 400 ppm, to obtain the “Reference Sample.”

### Comparative Example 1: Preparation of “Comparative Detergent 1”

A comparative detergent comprising a 1-5% w/w of benzyl-C₁₂₋₁₈alkyldimethyl ammonium chloride, a D-glucopyranose, a color additive, and a solvent was obtained from a commercial detergent and labelled as “Comparative Detergent 1.” This comparative detergent has a neutral pH and does not contain a stabilizer, enzyme, or quaternary ammonium compound as described in this disclosure.

### Comparative Example 2: Preparation of “Comparative Detergent 2”

A comparative detergent comprising up to 1% w/w subtilisin, 0.1-0.5% w/w lipase, 0.1-0.5% w/w amylase, and up to 1% w/w ethoxylated C₉-C₁₁ alcohol was obtained from the commercial detergent Endozime® Bio-Clean and labelled as “Comparative Detergent 2.” This comparative detergent has a neutral pH and does not contain a stabilizer or quaternary ammonium compound as described in this disclosure.

### Comparative Example 3: Preparation of “Comparative Detergent 3”

A comparative detergent comprising 1-3% w/w sodium hydroxide, 1-2% w/w sodium octyl sulfate, 0.5-1.5% w/w 2-phosphono-1,2,4-butanetricarboxylic acid, 1-2% w/w 1-octamine N,N′-dimethyl-,N-oxide, and 0.5-1.5% w/w methyl oxirane polymer was obtained from a commercial detergent and labelled as “Comparative Example 3.” This comparative detergent is mildly alkaline and does not contain a stabilizer, enzyme, or quaternary ammonium compound as described in this disclosure.

### Comparative Example 4: Preparation of “Comparative Detergent 4”

A comparative detergent comprising up to 20% w/w of tetrapotassium pyrophosphate was obtained from a commercial detergent and labelled as “Comparative Detergent 4.” This comparative detergent is mildly alkaline and does not contain an enzyme, non-ionic surfactant, or quaternary ammonium compounds as described in this disclosure.

### Example 1: Preparation of “Inventive Detergent 1”

A detergent of the present disclosure was prepared by weighing out 0.15 g (0.15% w/w) of sodium bicarbonate and 0.02 g (0.02% w/w) of sodium carbonate into a 250 mL glass beaker. Subsequently, 25 g of deionized water was added to the glass beaker. The solution was then mixed until all solids dissolved.

After all solids had dissolved, 25 g (25.0% w/w) of propylene glycol was added to the glass beaker. Subsequently, 0.02 g (0.01% w/w) of D&C Green No. 5 and 0.01 g (0.01% w/w) of Antifoam C Emulsion were added to the glass beaker. The solution was mixed well.

Thereafter, 1 g of tetrasodium-N,N-bis(carboxymethyl)-L-glutamate (40% in water) (1.0% w/w), 10 g of BTC 1010-80 (containing DDAC at 80%) (8.0% w/w of DDAC), and 2 g (2.0% w/w) of Tergitol® 1× Min Foam (containing >97.0% alcohol alkoxylate) were added into the glass beaker. The solution was mixed well. Subsequently, 4 g (4.0% w/w) of a commercial product (containing subtilisin) was added to the glass beaker. The solution was again mixed well.

Next, approximately 42.8 g of deionized water (total amount of water approx. 61.8% w/w) was added to the glass beaker. The resulting solution was then mixed for about 15 minutes, or until the solution became a homogeneous dark green solution with no visible particulate matter. The pH of the mixed solution was then measured and adjusted, as needed, such that the final pH of the mixed solution was between 9.5 and 10.5 to obtain the “Inventive Detergent 1.”

### Example 2: Preparation of “Inventive Detergent 2”

Inventive Detergent 2 was prepared in the same manner as Inventive Detergent 1 except that 0.005% w/w of propionic acid (CAS: 79-09-4) was included.

### Example 3: Preparation of “Inventive Detergent 3”

Inventive Detergent 3 was prepared in the same manner as Inventive Detergent 1 except that 0.005% w/w of N,N-dimethyldodecylamine (CAS: 112-18-5) was included.

### Example 4: Corrosion Inhibition Activity

The corrosion inhibition activities of the Inventive Detergents 1-3, the Comparative Detergents 1-4, and the Reference Sample were compared by immersing low carbon steel discs into the respective samples for a period of one year and then measuring the reduction in diameter of the non-corroded portion of the discs to calculate a “corrosion rate” (in mm per year). Table 1 below tabulates the measured corrosion rates of the low carbon steel discs for the tested detergents.

TABLE 1
Corrosion rates for low-carbon steel

| Sample | Corrosion Rate (mm/yr) |
|---|---|
| Reference Sample | −0.080 |
| Comparative Detergent 1 | −0.060 |
| Comparative Detergent 2 | −0.048 |
| Comparative Detergent 3 | −0.037 |
| Comparative Detergent 4 | −0.032 |
| Inventive Detergent 1 | −0.011 |
| Inventive Detergent 2 | −0.009 |
| Inventive Detergent 3 | −0.008 |

As shown in Table 1, the Inventive Detergents 1-3 exhibited significantly lower corrosion rates (−0.011 mm/yr, −0.009 mm/yr and −0.008 mm/yr respectively) compared to the Reference Sample (−0.080 mm/yr) and the Comparative Examples 1-4 (−0.060 mm/yr, −0.048 mm/yr, −0.37 mm/yr and −0.032 mm/yr respectively). This study demonstrates the importance of including a combination of the stabilizer (e.g., propylene glycol), enzyme (e.g., subtilisin), non-ionic surfactant (e.g., alcohol alkoxylate), and quaternary ammonium compound (e.g., DDAC) in the inventive detergents. Furthermore, it was surprisingly discovered that the improvement in noncorrosive activity can be due to the presence of the cationic surfactant (i.e., quaternary ammonium compound (DDAC)), which was not previously known to inhibit corrosion and is not commonly used as a corrosion inhibitor. In addition, the results for Inventive Detergents 2 and 3 show that the addition of an acid (i.e., propionic acid) or a base (i.e., N,N-dimethyldodecylamine) does not significantly affect the corrosion rates for low carbon steel.

### Example 5: Material Compatibility Study

Material compatibility of the in-use detergent of Inventive Detergent 1 was determined by placing a low carbon steel test sample in the in-use detergent at 40° C. for 48 hours. Then, the exposed test sample was visually inspected for any visible damage or cracks. No cracks were observed on the exposed low carbon steel test sample.

### Example 6: Cleaning Efficiency of Inventive Detergent Based on Biofilm Removal

A study was carried out to assess the manual cleaning efficiency of InventiveDetergent 1 based on residual protein, residual total organic carbon (TOC) and reduction in bacteria.

As used herein, the term “manual cleaning” refers to the cleaning of a biofilm at a slow flow rate, followed by a rinse with water. The slow flow rate is carried out using in-use detergents (i.e., detergents diluted with water) as described herein.

To evaluate cleaning efficiency, a mono-bacterial biofilm was prepared inside polytetrafluoroethylene (PTFE) tubing in accordance with ISO 15833-5:2021 and ISO/TS 15883-5:2005. The biofilm was then incubated, and test pieces were created by disconnecting the media feed tube and adding sterile water to remove planktonic cells and loosely associated biofilm. The PTFE tubing was subsequently wiped with 70% isopropyl alcohol. Thereafter, the PTFE tubing was cut into short pieces ranging from 10 cm to 30 cm. These small pieces of the PTFE tubing were connected to a surrogate washing device having flaking tubings connected to each side of the PTFE tubing.

Next, the in-use detergent of Inventive Detergent 1 (i.e., ranging from 0.8% to 1% diluted in 400 ppm hard water), was equilibrated at 30° C., and then flushed into a surrogate washing device by a peristaltic pump at a slow flow rate for several minutes. Thereafter, a rinsing step was performed in which hard water at 30° C. was flushed at a slow flow rate to produce the test sample.

Testing of the efficacy of removing biofilm was then performed by measuring average residual protein and average total organic carbon (TOC) according to ISO 15:88305:2021 and AAMI ST98.

Table 2 shows the average protein remaining, Table 3 shows the average TOC remaining, and Table 4 shows the average reduction of bacterial log cell count that resulted from the evaluation of cleaning efficiency using the in-use detergent of Inventive Detergent 1.

TABLE 2
Measured Average Residual Protein

| Sample | Average Protein Remaining |
|---|---|
| In-Use Detergent re: | 3.7 μg/cm² |
| Inventive Detergent 1 | |

TABLE 3
Measured Average TOC Remaining

| Sample | Average TOC Remaining |
|---|---|
| In-Use Detergent re: | 7.4 μg/cm² |
| Inventive Detergent 1 | |

TABLE 4
Measured Average Reduction of Bacterial Log Cell Count

| | Average Reduction of |
|---|---|
| Sample | Bacterial Log Cell Count |
| In-Use Detergent re: | 6.8 cfu/cm² |
| Inventive Detergent 1 | |

### Example 7: Comparative Study of Cleaning Efficiencies Based on Biofilm Removal

Comparative studies were carried out to assess the manual cleaning efficiency of Inventive Detergent 1 (prepared in Example 1) as compared to a Control Sample and the Comparative Detergent 2 (i.e., Endozime® Bio-Clean) (prepared in Comparative Example 2) as measured based on residual protein, residual total organic carbon (TOC), and reduction in bacteria. The “Control Sample” was a non-treated positive control obtained directly after growth of the biofilm.

To evaluate cleaning efficiency, mono-bacterial biofilms were prepared in accordance with ISO 15833-5:2021 and ISO/TS 15883-5:2005. The biofilms were then incubated, and test pieces were created by disconnecting the media feed tube and adding sterile water to remove planktonic cells and loosely associated biofilm. The PTFE tubing was subsequently wiped with 70% isopropyl alcohol. Thereafter, the PTFE tubing was cut into short pieces ranging from 10 cm to 30 cm. These small pieces of the PTFE tubing were connected to a surrogate washing device having flaking tubings connected to each side of the PTFE tubing.

Next, the samples were equilibrated at 30±2° C. and then flushed into a surrogate washing device by a peristaltic pump at a low flow rate of 250 mL/min for 8 minutes. Thereafter, a rinsing step was performed in which hard water at 30° C. was flushed at a slow flow rate to produce the test samples.

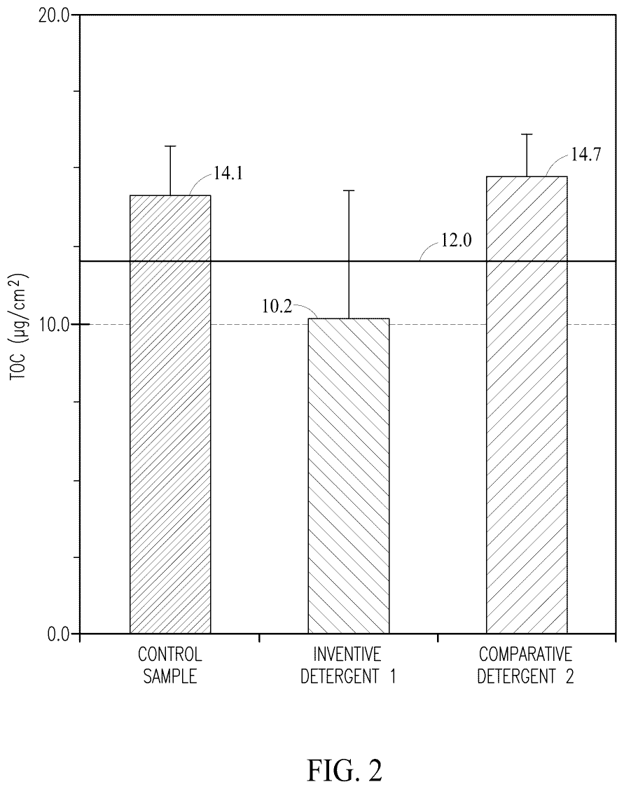

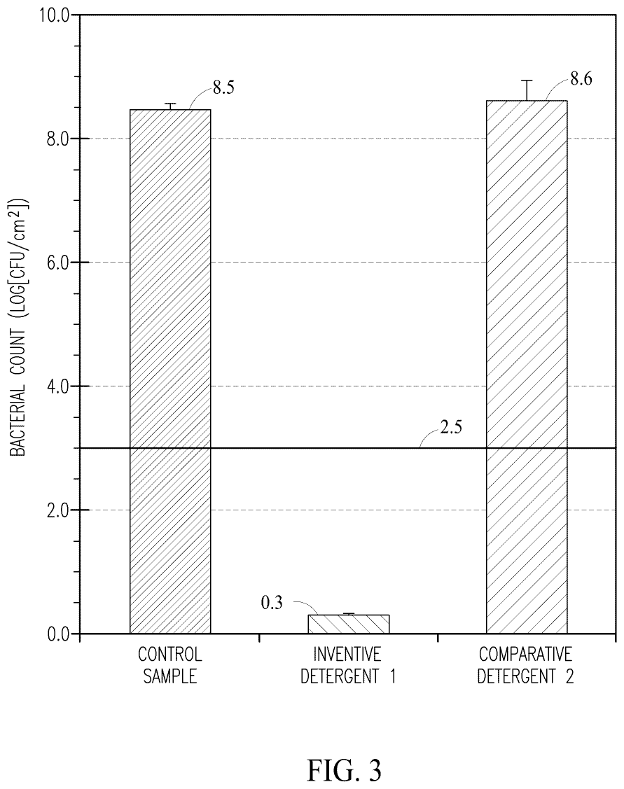

Testing of the efficiency of removing biofilm was then performed by measuring Average Protein Remaining and Average Total Organic Carbon (TOC) according to ISO 15:88305:2021 and AAMI ST98 for the Control Sample, Inventive Detergent 1, and Comparative Detergent 2. FIG. 1 shows a chart comparing the Average Protein Remaining for the tested samples relative to the preferred Average Protein Remaining threshold of ≤6.4 g/cm² in accordance with ISO 15883-5: 2021. FIG. 2 shows a chart comparing the Average TOC for the tested samples relative to the preferred Average TOC threshold of ≤12 g/cm² in accordance with ISO 15883-5: 2021. FIG. 3 shows a chart comparing the Bacterial Count for the tested samples relative to the preferred Bacterial Count threshold of ≤2.5 Log[CFU/cm²]. The average reduction in Bacterial Log Cell Count was calculated for these samples based on the measured Bacterial Counts. Table 5 below tabulates the comparative cleaning efficiency data for the Control Sample, the Comparative Detergent 1, and the Comparative Example 1.

TABLE 5
Biofilm Cleaning Efficiency at Low Flow Rate (250 mL/min)

| | | | | Average Reduction |
|---|---|---|---|---|
| | | Average Protein | Average TOC | of Bacterial Log |
| | Process | Remaining | Remaining | Cell Count |
| Sample | Conditions | (pref. ≤6.4 μg/cm²) | (pref. ≤12.0 μg/cm²) | (pref. ≥6.0 log) |
| Control | 250 mL/min | 23.4 ± 3.6 μg/cm² | 14.1 ± 1.6 μg/cm² | 0.0 log |
| Comparative | for 8 | 21.4 ± 2.0 μg/cm² | 14.7 ± 1.4 μg/cm² | 0.0 log |
| Detergent 2 | minutes at | | | |
| Inventive | 30 ± 2° C. | 5.1 ± 2.4 μg/cm² | 10.2 ± 4.1 μg/cm² | 8.2 log |
| Detergent 1 | | (Δ~18.3 μg/cm²) | (Δ~3.9 μg/cm²) | |

As summarized in Table 5 above, by reference to FIGS. 1-3, Inventive Detergent 1 was found to be a far superior detergent for removing biofilm compared to Comparative Detergent 2 (i.e., Endozime® Bio-Clean). Inventive Detergent 1 exhibited a four-fold reduction in average protein remaining, a roughly thirty percent reduction in average TOC remaining, and an eight-fold higher average reduction of bacterial log cell count compared to Comparative Detergent 2, see FIGS. 1-3.

To assess the effect of washing flow rate on the efficiency of biofilm removal, another comparative study was performed in which the washing flow rate was increased to 1,000 mL per minute, and Inventive Detergent 1 was compared to the Control Sample. As summarized in Table 6 below (by reference to Table 5), increasing the washing flow rate by four-fold to 1,000 mL/min led to a significant reduction in the Average Protein Remaining (Δ˜80.4 g/cm²@ 1,000 mL/min versus Δ ˜18.3 μg/cm²Ε 250 mL/min) and Average TOC Remaining ((Δ˜32.9 ag/cm²@1,000 mL/min versus Δ ˜3.9 μg/cm²@250 mL/min) for the Inventive Detergent 1 compared to the washing flow rate of 250 mL per minute.

TABLE 6
Biofilm Cleaning Efficiency at High Flow Rate (1,000 mL/min)

| | | | | Average Reduction |
|---|---|---|---|---|
| | | Average Protein | Average TOC | of Bacterial Log |
| | Process | Remaining | Remaining | Cell Count |
| Sample | Conditions | (pref. ≤6.4 μg/cm²) | (pref. ≤12.0 μg/cm²) | (pref. ≥6.0 log) |
| Control | 1,000 | 85.6 ± 5.2 μg/cm² | 36.4 ± 6.4 μg/cm² | 0.0 log |
| Inventive | mL/min for | 5.2 ± 3.5 μg/cm² | 3.5 ± 2.8 μg/cm² | 6.4 ± 1.2 log |
| Detergent 1 | 5 minutes at | (Δ~80.4 μg/cm²) | (Δ~32.9 μg/cm²) | |
| | 30 ± 2° C. | | | |

### Example 8: Effect of Quaternary Ammonium Compound Concentration

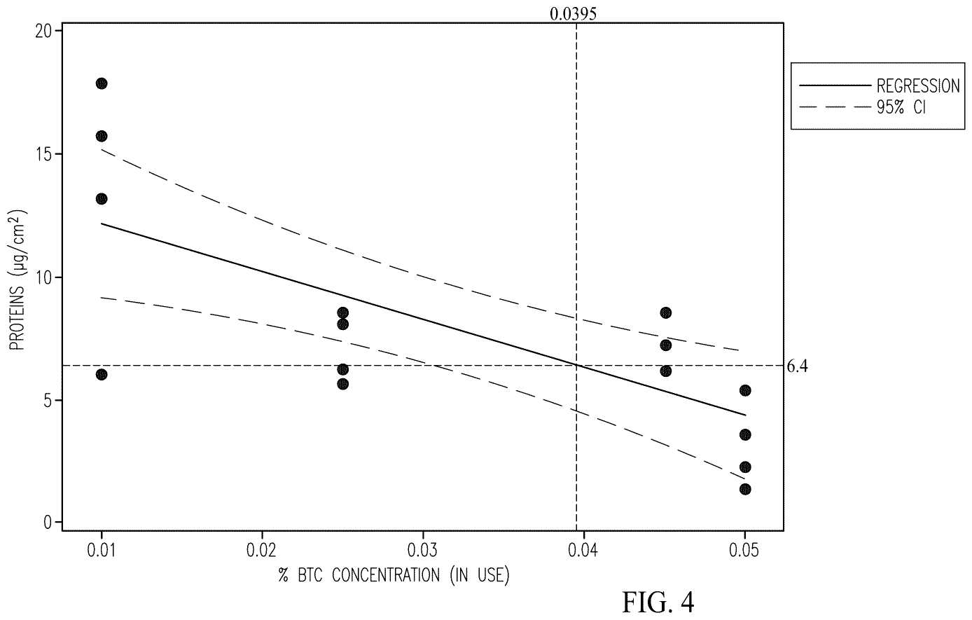

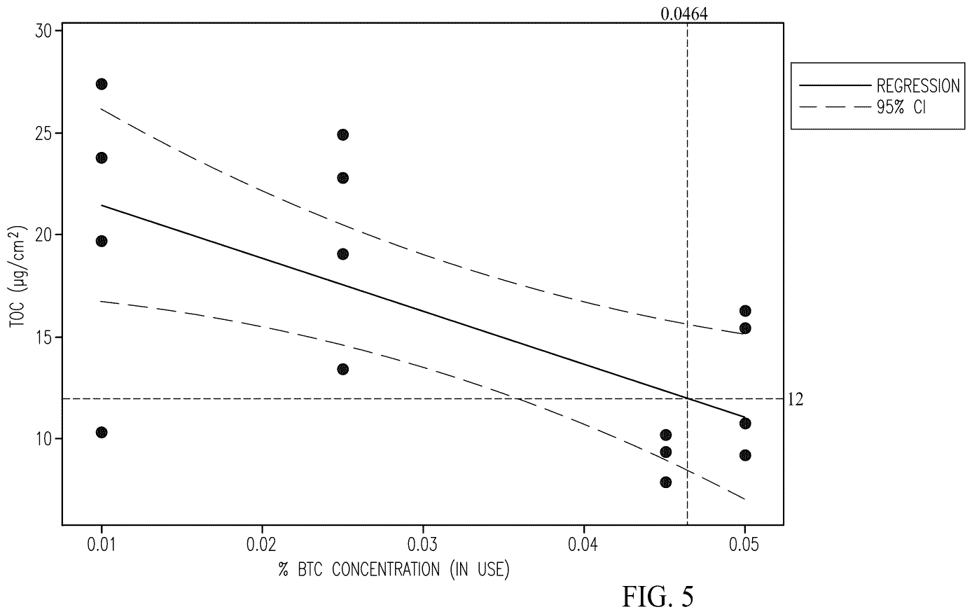

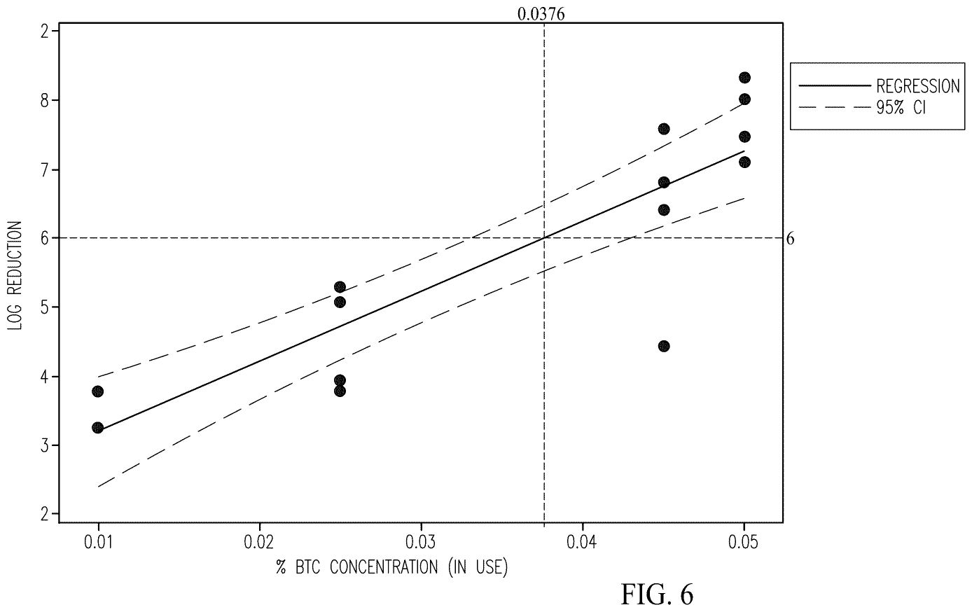

A further study was carried out to understand how the concentration of the quaternary ammonium compound affects biofilm cleaning efficiency. In-use detergents were prepared in accordance with Example 1 except that the proportion of BTC® 1010-80% was modulated. The detergents were diluted at 1:100 fold for in-use. FIGS. 4-6 show graphs of the concentration of BTC® 1010-80% versus (i) residual proteins from biofilm (FIG. 4), (ii) average TOC remaining (FIG. 5), and (iii) Log reduction in biofilm (FIG. 6)—as well as linear regression curves showing the best-fit curve for each experiment.

It was discovered that increasing the concentration of quaternary ammonium compound (BTC® 1010-80) can improve the biofilm cleaning efficacy (i.e., less residue of proteins, less residue of organic matters, and higher log reduction/removal of bioburden). As illustrated in FIGS. 4-6, when the concentration of BTC® 1010-80 exceeds about 0.046% (w/w) (FIG. 5) preferred levels of Average Protein Remaining (pref. ≤6.4 μg/cm²), Average TOC Remaining (pref. ≤12.0 μg/cm²) and Average Reduction of Bacterial Log Cell Count (pref. ≥6.0 log) are simultaneously attained.

### Example 9: Comparative Study of Simethicone Cleaning Performance

During a typical GI endoscopic procedure, simethicone defoaming agents are commonly used to clear bubbles from mucosal surfaces and to improve visualization. Simethicone is a mixture of dimethicone and silicon dioxide, which is insoluble in water and alcohol. Due to its solubility, the use of simethicone during the GI endoscopic procedures can lead to residual simethicone even after reprocessing steps. Leftover simethicone residues can potentially promote the growth and formation of biofilm.

To evaluate the performance of different detergents for removing simethicone, comparative solubility studies were carried out using the Inventive Detergent 1 (prepared in Example 1) in comparison to the Comparative Detergent 2 (i.e., Endozime® Bio-Clean) (see Comparative Example 2) and the commercial detergent Intercept™ (detergent containing 1-5% diethylene glycol monomethyl ether, 1-5% quaternary ammonium chloride of benzyl-C₁₂₋₁₈alkyldimethyl quaternary ammonium chloride, and 0.5-1.5% D-glucopyranose oligomeric decyl octyl glycosides) (hereinafter referred to as “Comparative Detergent 5”).

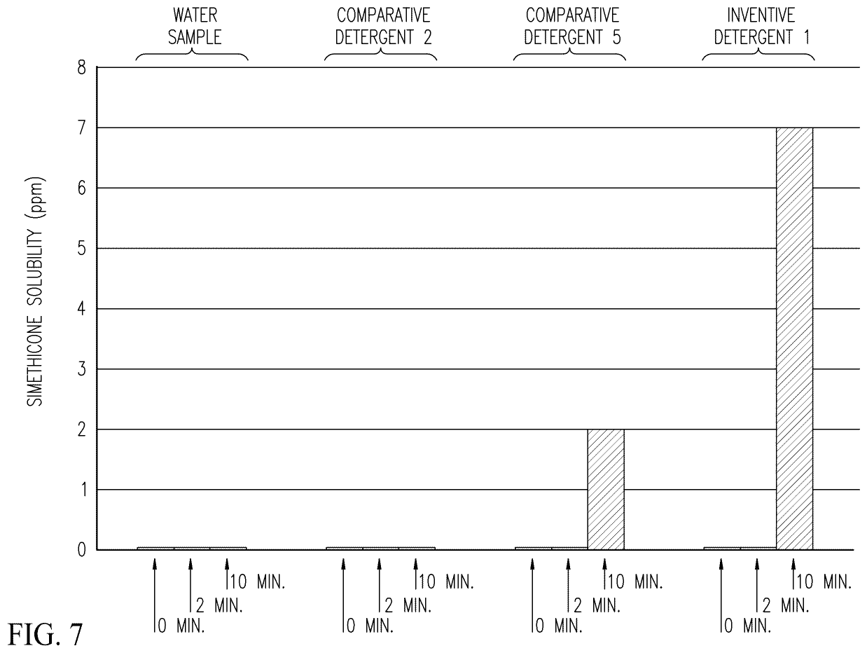

To evaluate the relative solubility of simethicone, the in-use solutions of Inventive Detergent 1, Comparative Detergent 2, and Comparative Detergent 5 (diluted with water at ratios ranging from 0.1-2.0% v/v before use) were saturated with simethicone (United States Pharmacopeia grade). The concentrations of simethicone solubilized in the in-use detergent solutions were then characterized using high-performance liquid chromatography (HPLC) equipped with a mass spectrophotometry (MS) detector for mixing times ranging from 0 minutes to 10 minutes (the typical cleaning time). FIG. 7 shows charts of simethicone solubility over different mixing times (0, 2, and 10 minutes) for the in-use solutions of Inventive Detergent 1, Comparative Detergent 2, and Comparative Detergent 5 as compared to a control sample of water.

As shown in FIG. 7, the simethicone solubility of the in-use Inventive Detergent 1 solution outperformed the Comparative Detergent 2 (i.e., Endozime® Bio-Clean) and the Comparative Detergent 5 (i.e., Intercept™) at a mixing time of 10 minutes. Although the in-use Comparative Detergents 5 (i.e., Intercept™) exhibited measurable simethicone solubility after 10 minutes of mixing, simethicone was found to be 3.5 times more soluble in the in-use Inventive Detergent 1 at the mixing time of 10 minutes.

To visually evaluate the ability to disperse (break down the simethicone layer), indigo blue dye-stained simethicone was added to different in-use detergent solutions and water. The tested detergent solutions included Inventive Detergent 1, Comparative Detergent 2 (i.e., Endozime® Bio-Clean), Comparative Example 5 (i.e., Intercept™), and the commercial detergent Prolystica® 2× Concentrated Enzymatic (detergent containing 10-30% C₁₂₋₁₄ secondary, ethoxylated alcohols, 1-5% subtilisin and 5-10% glycerin) (hereinafter referred to as “Comparative Detergent 6”)-all as in-use detergents. Indigo dye is insoluble in water and was used for the ease of visualization of the simethicone layer.

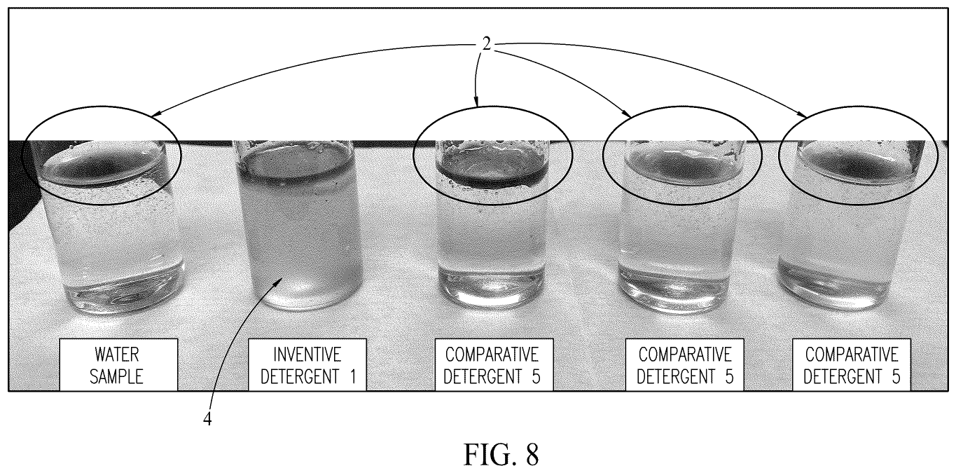

As shown in FIG. 8, the blue-stained simethicone initially formed a well-defined layer 2 (indicative of a heterogeneous mixture) in the water sample and in all detergent samples (oil-in-water effect due to its insolubility). After vigorous mixing of all solutions for ˜15-20 seconds, the blue-stained simethicone was visually more dispersed in the in-use Inventive Detergent 1 solution compared to tap water and the commercial detergents (FIG. 8). This indicated the best-in-class ability of the Inventive Detergent 1 to break down a layer of simethicone, which can lead to more effective cleaning of simethicone residues from medical device equipment using the Inventive Detergent 1 in comparison to Comparative Detergent 2 (i.e., Endozime® Bio-Clean), Comparative Detergent 5 (i.e., Intercept™), and Comparative Detergent 6 (Prolystica® 2× Concentrated Enzymatic). Furthermore, the dispersion formed by using the in-use Inventive Detergent 1 is devoid of any foaming, as illustrated in FIG. 8.

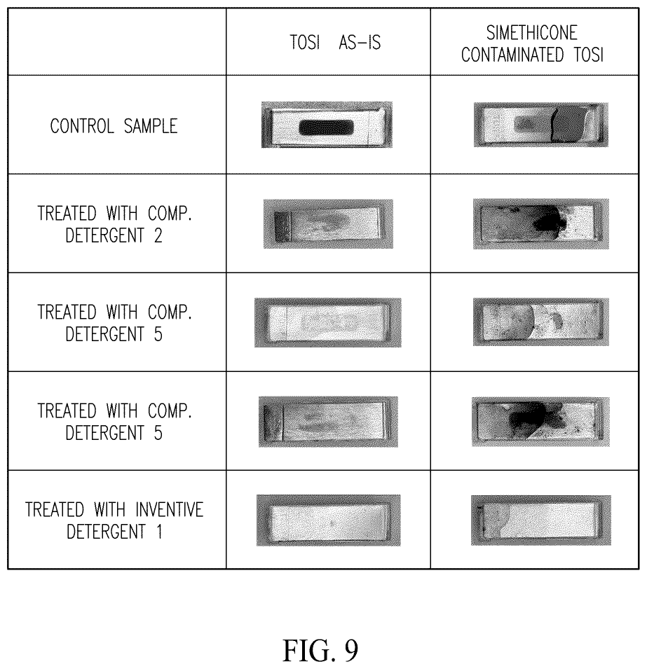

The ability of Inventive Detergent 1 to clean TOSI® coupons (HealthMark, product number: WT-101) was also evaluated. The TOSI® coupon is designed for cleaning verification in automated instrument washers, ultrasonic cleaners, and cart washers. In this study, a series of TOSI® coupons were cleaned using sonication at ambient temperature for 10 minutes to 15 minutes with different detergents, as compared to a control experiment using no detergent. FIG. 9 shows the results for these comparative experiments.

The results indicate that all detergents can remove the soil from TOSI® coupons (middle column of the table in FIG. 9). The removal of soil from simethicone contaminated TOSI® coupons was greatly diminished, however, for the Comparative Detergent 2 (i.e., Endozime® Bio-Clean), the Comparative Detergent 5 (i.e., Intercept™), and the Comparative Detergent 6 (i.e., Prolystica® 2× Concentrated Enzymatic) (right column of table in FIG. 9). For the comparative detergents, the layer of simethicone potentially created a blockage to disallow the ability of the detergents to clean the soil. In contrast, the removal of soil from a simethicone contaminated TOSI® coupon was effective using Inventive Detergent 1. These observations can be due to the exceptional ability of the Inventive Detergent 1 to solubilize simethicone (FIG. 7) and the atypical ability of this detergent to disperse simethicone (FIG. 8).

### Example 10: Illustrative Detergent

An illustrative detergent of the present disclosure includes a stabilizer, an enzyme, a surfactant, and an antimicrobial agent, and the detergent has a pH ranging from about 8.5 to about 11.5. The antimicrobial agent is optionally a quaternary ammonium compound, the stabilizer may include a plurality of stabilizers, the enzyme may include a plurality of enzymes, the surfactant may include a plurality of surfactants (such as an ionic surfactant and/or a non-ionic surfactant), and/or the antimicrobial agent may include a plurality of antimicrobial agents (such as a plurality of quaternary ammonium compounds). The detergent optionally includes a first stabilizer, at least one enzyme, a non-ionic surfactant, a quaternary ammonium compound, and water, such that the detergent has a pH ranging from 8.5 to 11.5. Optionally, the stabilizer is present in an amount ranging from 15% w/w to 50% w/w. Optionally, the stabilizer comprises ethylene glycol, propylene glycol, butylene glycol, glycerin, or any combination thereof. Optionally, the enzyme is present in an amount up to 2.0% w/w. Optionally, the enzyme includes a cysteine, a serine, a threonine, a protease, or any combination thereof. Optionally, the enzyme includes a protease, such as subtilisin. Optionally, the non-ionic surfactant is present in an amount ranging from 1% w/w to 5% w/w. Optionally, the non-ionic surfactant includes an alcohol alkoxylate. Optionally, the quaternary ammonium compound is present in an amount ranging from 0.8% w/w to 8% w/w. Optionally, the quaternary ammonium compound includes an alkyl quaternary ammonium compound or an aromatic alkyl quaternary ammonium compound. Optionally, the quaternary ammonium compound includes didecyldimethylammonium chloride. Optionally, the detergent includes a first pH buffer agent, a second pH buffer agent, or a combination thereof; and optionally, the first pH buffer agent is present in an amount up to 1% w/w, and the second pH buffer agent is present in an amount up to 0.20% w/w. Optionally, the detergent includes a first pH buffer agent selected from the group consisting of sodium bicarbonate, 4-morpholineethanesulfonic acid, sodium phosphate tribasic, and 3-(cyclohexylamino)-1-propanesulfonic acid. Optionally, the detergent includes a second pH buffer agent selected from the group consisting of sodium carbonate, sodium hydroxide, sodium phosphate dibasic, and hydrochloric acid. Optionally, the detergent includes an antifoaming agent, a defoamer, or a combination thereof. Optionally, an antifoaming agent, a defoamer, or a mixture thereof, is present in an amount ranging from 0.001% w/w to 0.02% w/w. Optionally, the detergent includes a silicone-containing antifoaming agent. Optionally, the detergent includes a water softener, preferably in an amount ranging from 0.04% w/w to 8% w/w. Optionally, the detergent includes a water softener containing tetrasodium-N,N-bis(carboxymethyl)-L-glutamate, N,N-(carbamoylmethyl)imino diacetic acid, ethylene-diaminetetraacetic acid, or any combination thereof. Optionally, the detergent may include a second stabilizer, preferably in an amount up to 10% w/w. Optionally, the detergent includes a second stabilizer selected from methanol, ethanol, propanol, isopropanol, or any combination thereof. Optionally, the detergent includes 20-30% w/w of the first stabilizer; 0.2% w/w to 1.5% w/w of the enzyme; 1.0% w/w to 3.0% w/w of the non-ionic surfactant; 3.0% w/w to 6.5% w/w of the quaternary ammonium compound; 0.1% w/w to 0.2% w/w of a first pH buffer agent; 0.01% w/w to 0.03% w/w of a second pH buffer agent; 0.05% w/w to 0.15% w/w of an antifoaming agent; and 0.1% w/w to 2.0% w/w of a water softener. Optionally, the pH of the detergent ranges from 9.5 to 10.5. The detergent is optionally noncorrosive to metals. Optionally, when the detergent is in contact with a low carbon steel, the low carbon steel exhibits a corrosion rate of 0.015 mm/year or less. Optionally, the detergent is configured to denature biofilm proteins exposed to the detergent, such that an amount of protein is reduced to 6.4 μg/cm² or less following contact with the detergent. Optionally, the detergent is configured to remove biofilm organic material exposed to the detergent, such that an amount of total organic carbon is reduced to 12.0 μg/cm² or less following contact with the detergent. Optionally, the detergent is configured to clean biofilm bacteria exposed to the detergent, such that a bacteria log cell count (cfu/cm²) is reduced by 6.0 log or more relative to a non-treated sample following contact of the sample with the detergent.

### Example 11: Illustrative Method for Using a Detergent

An illustrative method involves cleaning an object by contacting the object with a detergent including a stabilizer, an enzyme, a surfactant, and an antimicrobial agent, and the detergent has a pH ranging from about 8.5 to about 11.5. The object may comprise an endoscope, and the method is optionally carried out using an automatic endoscope reprocessor. Optionally, the method occurs at an operating temperature from 15° C. to 60° C. The detergent may include any detergent in Example 10.

Although the disclosure herein has been described with reference to particular examples, it is to be understood that these examples are merely illustrative of the principles and applications of the present disclosure. For example, features described in relation to one particular example may be combined with features of other examples described herein. It is therefore to be understood that numerous modifications may be made to the illustrative examples and that other arrangements may be devised without departing from the spirit and scope of the present disclosure as defined in the appended claims

1. A detergent, comprising:
a stabilizer;
an enzyme;
a non-ionic surfactant; and
a quaternary ammonium compound,
wherein the detergent has a pH ranging from 8.5 to 11.5.
